(19) United States
(12) Patent Application Publication
(10) Pub. No.: US 2002/0103650 A1
(43) Pub. Date: Aug. 1, 2002

(54) Sound generating amusement device

(76) Inventor: Ronald L. Lewis JR., Glen Mills, PA (US)

Correspondence Address: RONALD L. LEWIS, JR., AKIN, GUMP, STRAUSS, HAUER & FELD, L.L.P., One Commerce Square, 2005 Market Street - 22nd Floor, Philadelphia, PA, 19103-7086, US

(21) Appl. No.: 10/041,690

(22) Filed: Jan. 8, 2002

Related U.S. Application Data
(60) Provisional application No. 60/260,233, filed on Jan. 8, 2001.

(51) Int. Cl. G10L 21/00

(52) U.S. Cl. 704/272

(57) ABSTRACT

An amusement device includes an alcoholic container shaped housing; a sound synthesizer in the housing; a speaker in the housing and operably coupled with the sound synthesizer; a power supply in the housing operably coupled at least with the sound synthesizer; and a motion responsive switch in the housing operably coupled to the synthesizer for activation of the synthesizer when the device is moved. The device may be supplied with a prerecorded message or may be provided with a microphone, a recordable digital memory and a control circuit that permits the recordation of a message by the user, or both. A set of removably adherable novelty labels may be provided.

### CROSS-REFERENCE TO RELATED APPLICATIONS

This application is related to U.S. Provisional Patent Application No. 60/260,233, filed Jan. 8, 2001.

### BACKGROUND OF THE INVENTION

Recently, various versions of singing fish have been introduced as novelty items. Generally speaking, each includes some sort of a detector for activating a circuit within the fish when someone comes within range of the detector to cause the fish to play a prerecorded program of speech and song and to move in an animated fashion.

While such devices are entertaining, their entertainment value diminished quickly because of their widespread notoriety. The devices were originally intended to surprise users by self-activation. However, since mounted fish were not that common, as they became widely known, people would recognize them and anticipate their operation. This diminished the surprise aspect of their entertainment value.

### BRIEF SUMMARY OF THE INVENTION

The present invention is directed to a sound-generating alcoholic beverage container which is more common in appearance and therefore more easily disguised as a conventional utilitarian item so that the device is not readily identified by users before activated.

More particularly, the invention is an amusement device comprising: an alcoholic beverage container shaped housing; a sound synthesizer in the housing; a speaker in the housing and operably coupled with the sound synthesizer; a power supply in the housing operably coupled at least with the sound synthesizer; and a motion responsive switch in the housing operably coupled to the synthesizer activation of the synthesizer. The device, preferably housed to simulate an alcoholic drink container such as a wine bottle which, when moved, will play a recorded message. The device may either be supplied with a prerecorded message from the factory or reproduce a message recorded by the end user or do both.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a schematic representation of a device according to the present invention.

### DETAILED DESCRIPTION OF THE INVENTION

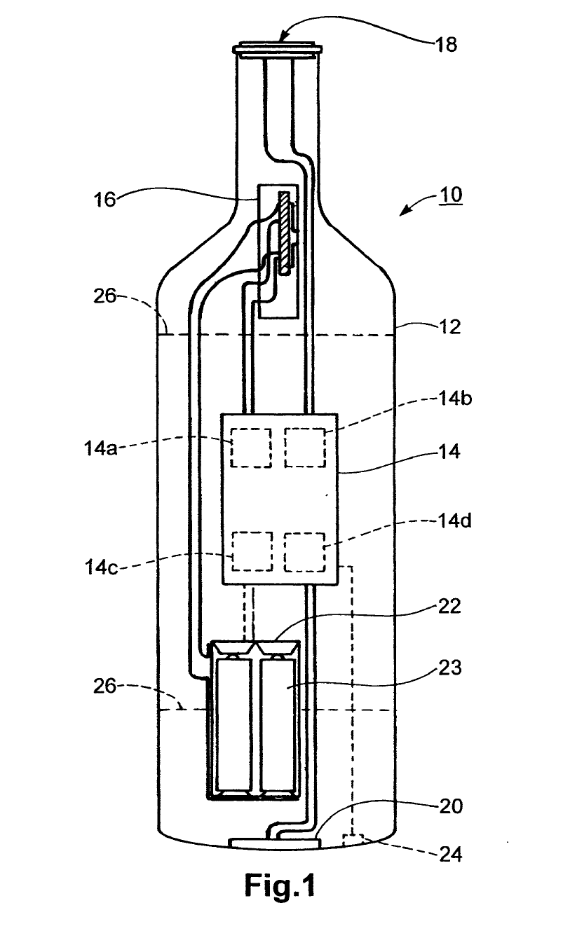

FIG. 1 depicts schematically an amusement device of the present invention indicated generally at 10. The device includes an alcoholic beverage container shaped housing 12, which contains a sound synthesizer (chip) indicated generally at 14 activated by a motion responsive switch 16. A speaker 18 is positioned on the upper side of the container to reproduce a sound message generated by the synthesizer chip. A microphone 20 may be located elsewhere on the housing 12, for example, in the base, where the user can record a message to be reproduced by the synthesizer chip 14. Finally, a battery power supply 22 preferably with one or more rechargeable or replaceable batteries 23 is provided to power the various components.

The housing 12 may be shaped like an alcoholic drink container, preferably a wine bottle as depicted, or other alcoholic beverage bottle or can. Preferably, housing 12 is made of plastic but might be made of a glass or wood, as desired. The synthesizer chip 14 can be a commercially available chip from any of a variety of sources including but not limited to Texas Instruments and Motorola. The chip preferably includes a microprocessor 14a, analog to digital and digital to analog converters 14b, an electronic Read Only Memory 14c for a factory supplied message that cannot be changed or a electronic Random Access Memory 14d for storing a changeable, user supplied message, or both memories, or equivalent circuitry configured to store and reproduce or record and reproduce an audible message transmitted through the microphone 20. One or more of the elements 14a-14d may also be stand alone components operably coupled with the other components to provide the synthesizer. If needed, one or more conventional switches 24 (in phantom) can be provided for operator control input to the synthesizer chip 14.

The motion response switch 16 may be any conventional mercury contact switch or other suitable motion switch (e.g., spring and pin, rolling ball, etc.) which closes an open circuit through the switch to supply power from the power supply 22 to the chip 14 or to activate the chip 14 to draw power directly from the power supply 22 (in phantom) for at least an operating cycle of the chip 14 in response to movement of the device.

Microphone 20 might be a piezoelectric element disguised as a cover in the mouth of the bottle/housing 12. Alternatively, a cone type speaker might be used beneath a porous, sound transmitting member disguised as a cover, cork, etc. in the mouth of the bottle/housing 12. If a piezoelectric member is used as the speaker 18, it may also be possible for it to perform double duty as a microphone. Alternatively, a separate microphone 20 should be provided in a hidden area of the housing 12 if the device 10 is configured as preferred to permit the ultimate user to record a personal message for reproduction. The circuitry and components are configured to be in a dormant state until the chip 14 is activated by closure of the switch 16 in response to movement of the device 10, in which case one or more messages prerecorded on the chip 14 is reproduced through the speaker 18.

Preferably, a label 26 (indicated in phantom) is provided on the housing 12 and would be printed to satirize a known alcoholic beverage or otherwise have an original satirical or humorous designation. For example, a wine bottle shaped housing 12 might bear a label with graphics and one of the following names: CHATEAU LACREEP ROTTENCHILD; CHUTEAU THE DOOR; SCREAMING BEAGLE; GO TAKE A FLYING LEAP; HURLING VINYARD; SUEME!; CHATEAU D'ECKEM; CHATEAU HAUT WHOGOESTHERE; CHATEAU COS ISAIDSO; CLOS D'WINDOW; DRY HEAVE; MYTENDONS CREAK; etc. If desired, the device 10 can be provided with several such labels for selective application to the housing 12. They may be supplied with an adhesive backing having a sufficiently light tack to the outer surface of housing 12 that they are removably adherable to the housing 12 and can be removed and exchanged. In this way, the device 10 can be disguised and repeatedly used with the same people and still achieve surprise.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An amusement device comprising:
an alcoholic beverage container shaped housing;
a sound synthesizer in the housing;
a speaker in the housing and operably coupled with the sound synthesizer;
a power supply in the housing operably coupled at least with the sound synthesizer; and
a motion responsive switch in the housing operably coupled to the synthesizer activation of the synthesizer.

2. The amusement device of claim 1 further comprising a microphone in the housing operably coupled with the synthesizer.

3. The amusement device of claim 1 wherein the synthesizer includes a random access memory configured to store, in electric form, an audible message transmitted through the microphone to the synthesizer.

4. The amusement device of claim 1 wherein a label is removably adhered over part of the housing.
